(19) United States
(12) Patent Application Publication
(10) Pub. No.: US 2016/0027067 A1
(43) Pub. Date: Jan. 28, 2016

(54) INTERACTIVE DIGITAL VIDEO PRODUCT PLACEMENT AND PURCHASING

(71) Applicant: 3Kinetic LLC, Waukesha, WI (US)

(72) Inventors: Deb Zindler, Hubertus, WI (US); Cory Zimmermann, Pewaukee, WI (US)

(73) Assignee: 3KINETIC LLC, Waukesha, WI (US)

(21) Appl. No.: 14/811,026

(22) Filed: Jul. 28, 2015

Related U.S. Application Data
(60) Provisional application No. 62/029,780, filed on Jul. 28, 2014.

(51) Int. Cl. G06Q 30/02; H04N 21/4722; H04N 21/478; G06Q 30/06

(52) U.S. Cl. CPC G06Q 30/0276; G06Q 30/0643; G06Q 30/0277; H04N 21/4722; H04N 21/47815

(57) ABSTRACT

A system and method for integrating product placement and on-line shopping into a digital video. The digital video is created with a plurality of placed products. When any frames of the digital video are displayed that include a placed product, a shopping indicator is shown on the display. The shopping indicator indicates that a placed product is available for purchase. When a viewer pauses the digital video, product markers are shown on the screen and aligned with the placed product. The product marker includes an electronic link to information about the placed product. A viewer can purchase the placed product directly within the digital video and can check out either during or after the video. Each link included in the product marker is directed to an on-line merchant that includes up-to-date, current purchasing information.

### CROSS-REFERENCE TO RELATED APPLICATION

The present application is based on and claims priority to U.S. Provisional Patent Application Ser. No. 62/029,780 filed Jul. 28, 2014, the disclosure of which is incorporated herein by reference.

### BACKGROUND

The present disclosure relates to a process by which filmmakers, movie studios, TV networks, etc. can create digital feature films, cinematic shorts, videos or TV shows (hereinafter collectively “digital video”) that allow viewers to interact with the digital video and directly and instantly purchase placed products through an on-line retailer/shopping service.

Traditionally, product placement in movies/TV shows is done through obvious placements (i.e.: logo placements) that appear in the theatrical/television release. Currently, there is no ability to directly track purchasing based on this type of product placement.

However, a digital video that is modified and enhanced in accordance with the present disclosure includes placed products that are digitally tagged or marked in a digital video post-production process such that the digital product markers are not obtrusive—they are seamlessly woven into the story via a new form of product placement. The placement is not reliant on logos. It is a showcase of the product in action with the ability for the viewer to pause playback of the digital video to review and ultimately purchase digitally tagged placed products instantly while viewing the digital video.

### SUMMARY

The present disclosure generally relates to a method and system for on-line shopping and product placement. More specifically, the present disclosure relates to a method and system that incorporates purchasing links to products placed in the digital video without interrupting the viewing experience of the digital video. The viewer decides whether or not they want to interact with the digitally tagged products utilizing the technology of the present disclosure and the viewer can directly shop from the digital video if they are interested in a product.

This type of product placement has the ability to be directly tracked with a determined, defined ROI. In particular, this type of product placement is highly appealing to the millennial customer who prefers not to be “sold” via traditional advertising but instead to discover, interact, experience and control their purchasing decisions.

In accordance with the present disclosure, the first step in the digitally tagging process starts at the movie studio or TV network level as the studio works to fund their project through product placement. Any type of product can be incorporated and placed into the digital video's development, including but not limited to clothing, shoes, jewelry, glasses, appliances, bikes, or the hundreds of thousands of products available for purchase on-line at retailers such as but not limited to Amazon or Zappos.

The studio approaches and receives product placement fees from specific brands/products to be included in the movie/TV show based on the script. Alternatively, product placement firms may work with their clients to have products incorporated into the digital video. Well known and famous brands of consumer products can launch a new product or an entire new product line through brand placement in this shop-able digital video. The use of the system and method of the present disclosure allows the brands to reach consumers without overt, direct and obvious placement of logos and brand identifiers within a digital video.

Once the final script and product placement has been determined, the production of the movie continues as usual—from pre-production to post-production to the final master and theatrical or television release. The placed products form part of the video as background or as items worn or used by the characters of the digital video.

Once the final theatrical/television edit is complete, the digital video goes into post-production to enhance the digital video utilizing the process and concept of the present disclosure. It is contemplated that product placement companies or the studio itself could control the post-production process to digitally tag products shown in individual frames of the digital video.

Every frame of the digital video is reviewed, and wherever there is a placed product available for purchase shown on screen, those scenes are digitally tagged. Code is written and implemented into the video viewer to allow the user to freeze the digital video at any scene upon a command from the viewer to pause playback. When the video is paused, product markers are superimposed over each of the placed product to indicate that additional purchasing information is available and that the product itself is available for purchase. If the viewer selects one of the product markers, the bidden, stored code, including an active hyperlink associated with each of the product markers pulls content from the on-line retailer's website. The content retrieved from the on-line retailer is displayed on the screen inside an informational screen of the graphic user interface (GUI). This information can include product pricing, different colors or styles or any other information relevant to the viewer's purchasing decision.

Once the final digitally tagging edit is complete, the enhanced digital video is digitally released via any number of online video services, including but not limited to Amazon Instant Video, Netflix, Hulu or other similar streaming services. Although the digital tagging initially occurs prior to release of the digital video, tags could be removed or added after the initial release depending on the success or lack of success of the product placement and the viewership of the video.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a view of a digital display device, such as a laptop, showing a digital video enhanced in accordance with the present disclosure;

FIG. 2 is a screenshot of the digital video including one of the shopping indicators;

FIG. 3 is a screenshot of the paused digital video showing the product markers positioned on the digitally tagged placed products;

FIG. 4 is a view of the informational display screen that includes information retrieved due to selection of one of the product markers;

FIG. 5 is a screenshot of the closing screen; and

FIG. 6 is a process flow map of the present disclosure.

### DETAILED DESCRIPTION

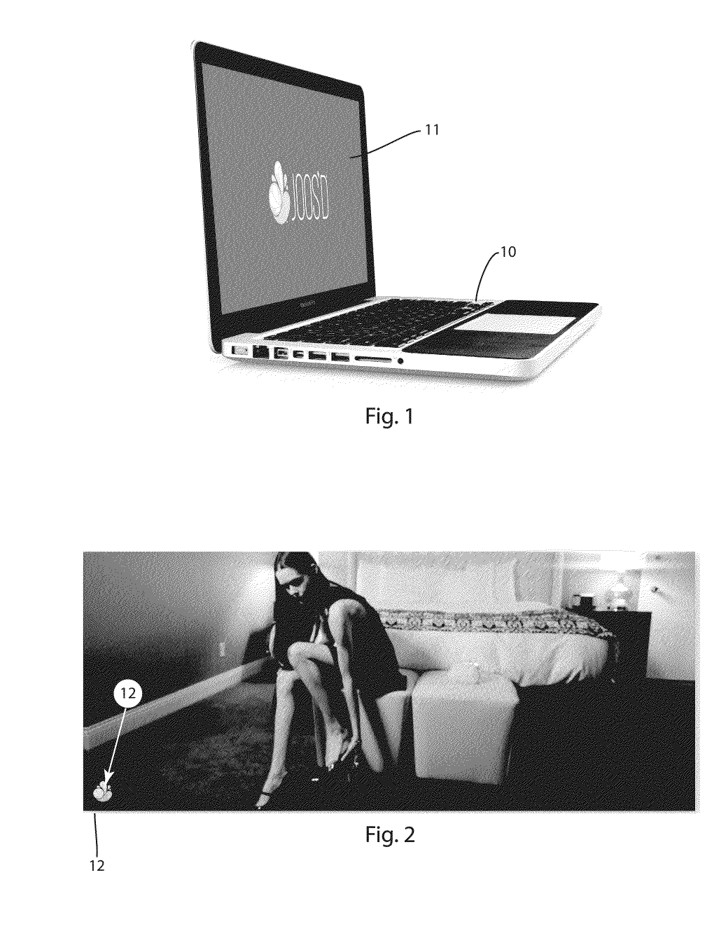

As shown in FIG. 1, when the customer/viewer begins to watch a digital video on their personal viewing display device 10, such as a laptop, tablet or smart phone, a series of introductory frames 11 are initially shown before the primary content of the digital video begins. The introductory frames 11 are added to the digital video after the digital video has been originally created and provide information to the viewer to let the viewer know that the digital video has been digitally tagged for shopping.

As the viewer watches the originally created movie or TV show, a shopping indicator 12 will appear somewhere on the screen to indicate that items shown in the current frame are available for purchase, as shown in FIG. 2. In the embodiment shown, the shopping indicator 12 is a small, unobtrusive symbol shown in the bottom right-hand corner of the display screen, indicating that something in the current frame is interactive and available for purchase. If there are no products in the frame available for purchase, the shopping indicator 12 will not be present. In this manner, the viewer is able to easily determine whether the viewer can pause the video to either obtain additional information about a product or ultimately purchase the product from within the digital video.

If the viewer does nothing, the digital video continues normal playback and the viewer is able to watch as they normally would. However, if the viewer chooses to interact with the digital video and the integrated shopping experience, the viewer will click anywhere on the display screen when the shopping indicator 12 is shown, such as in FIG. 2. When the viewer clicks on the screen, playback of the digital video pauses. Although clicking on the screen is described as one method of pausing playback, it should be understood that other methods are contemplated as being within the scope of the present disclosure. For example, if the display device 10 has a touch screen, the view could simply touch anywhere on the screen to pause playback. If the display device is a television that includes a remote controller, the viewer could press a “pause” button on the remote to pause playback of the digital video. Many other options are within the scope of the present disclosure to allow the viewer to selectively pause playback of the digital video.

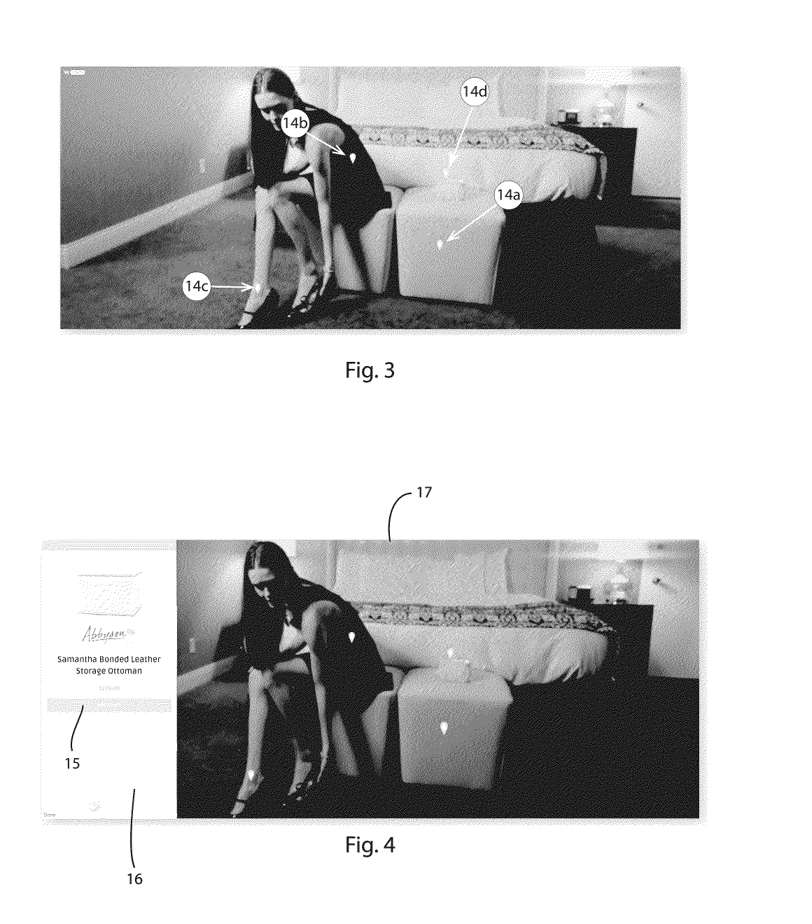

When the digital video is paused by the viewer, product markers 14 are superimposed over the products that have been intentionally placed in the digital video and digitally tagged during post-production of the digital video. FIG. 3 illustrated a frame of the digital video after playback has been paused and the product markers 14 are displayed. For example, if an actress is wearing a Nicole Miller dress, marker 14a shows up over the dress. Likewise a specific brand and model of an ottoman is used during filming and is tagged by marker 14b during post-production. Designer shoes are tagged by another marker 14c, and the purse carried by the actress is tagged with another marker 14d. Identification markers will be superimposed over all of the products that have been placed in the digital video and have been digitally tagged within the digital video.

If the viewer clicks a product marker 14, an informational display screen 16 appears (FIG. 4) next to a display area 17 that includes the paused frame of the digital video with the product markers 14. The informational display screen 16 includes product information, current pricing from an online merchant and a link to a shopping cart 15. The product is, at that instant, available for purchase through an on-line merchant, such as Amazon, Zappos, Google, etc. or directly from the product manufacturer.

During creation of each of the product markers 14 during post-production of the digital video, a post production company assigns an electronic hyperlink to a specific location at the on-line merchant to retrieve product information, availability of the product and current pricing for the product. Since each of the product markers 14 include a hyperlink to the on-line merchant rather than static, pre-stored information, when a view selects one of the product markers 14, the view is presented with current, up to date information about the product. The on-line merchant will update this information as part of their normal business model. The hyperlink to the on-line merchant is stored with all of the product markers 14 and shopping indicators as part of the enhanced digital file for the digital video. The digital file can be updated at any time should products no longer be available.

If the viewer wishes to purchase the product or products shown in the informational display screen 16, the viewer can click the “add to cart” button 15 and save that item in an on-line shopping cart. The viewer can then check-out either immediately or wait until the end of the digital video to complete their purchase.

To return to normal playback of the digital video, the viewer simply clicks the screen again and the digital video continues.

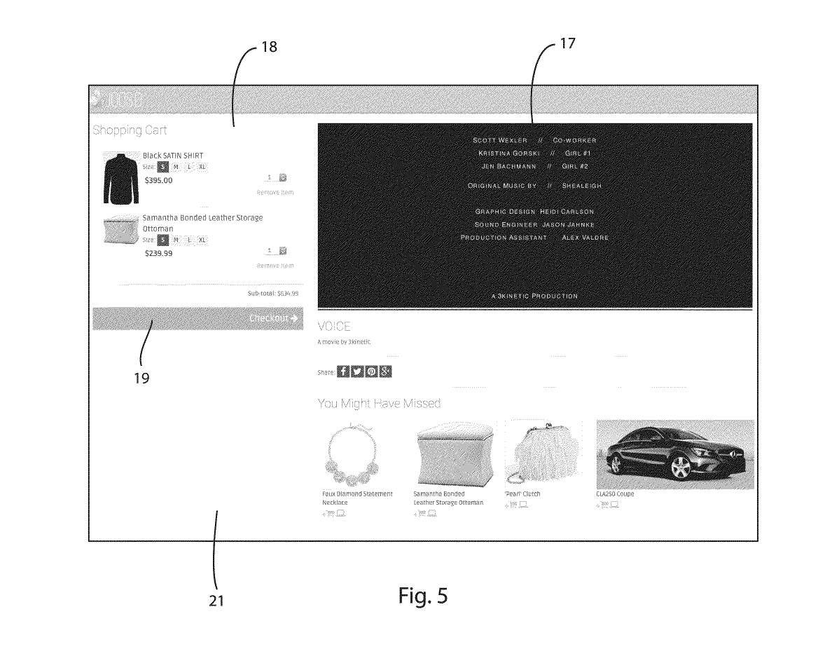

At the end of the playback of the digital video, as shown in FIG. 5, the display shifts to an shopping summary screen 21 that included the digital video display area 17 and the shopping cart status 18. At this time, the viewer can click on the checkout button 19 to begin the checkout process. The viewer completes their purchase with the on-line merchant who then fulfills the order and delivers the product in a normal manner.

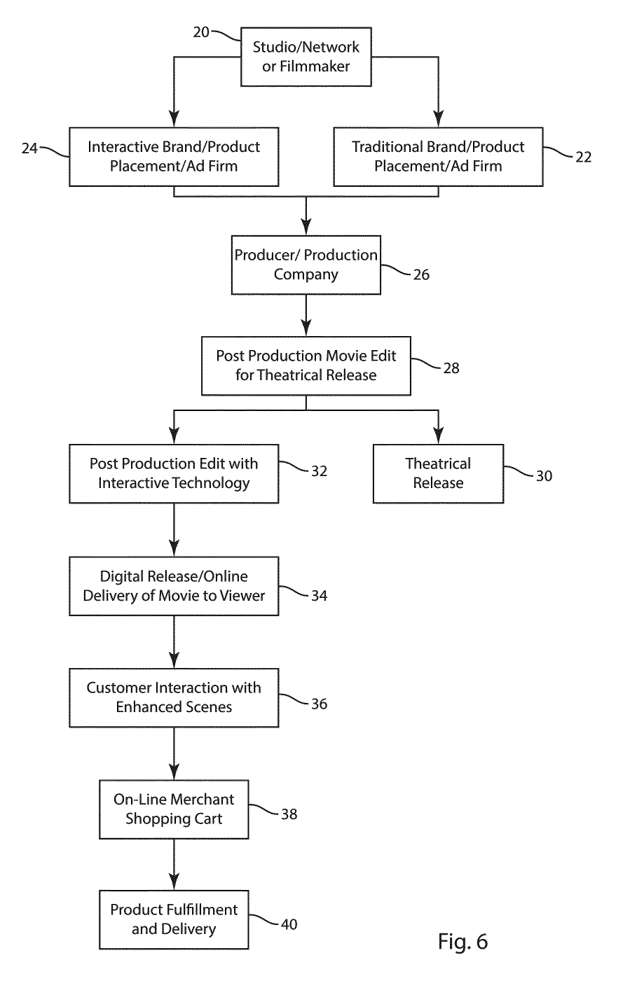

FIG. 6 illustrates a process map detailing the steps taken to digitally tag a digital video that allows for purchasing of products that are shown and displayed during playback of the digital video. Step 20 illustrates the filmmaker, television network or studio that is beginning the process of creating a new digital video, which could be a movie, television show or any other type of video product for viewing. The studio/filmmaker is often times in communication with a traditional marketing entity 22 to obtain additional revenue for the project through traditional product placement. In traditional product placement, a product manufacturer will pay the studio/filmmaker a set fee to include products on set so the product will be seen in the movie or television show. Although this type of product placement has been popular with both the studio/filmmaker and the product manufacturer, it is difficult to quantify the return on the advertising expenditure.

In accordance with the present disclosure, the studio/filmmaker can now contact an interactive marketing entity 24 that is able to digitally tag products specifically placed within the digital video, as discussed above. The product manufacturer will still pay a fee to have the product placed in the digital film, but with the method and system of the present disclosure, products will be able to be directly sold during playback of the video and the sales tracked. Once the filmmaker has selected the digital interactive marketing entity 24, the placed products are used on set and the film is produced as normal, as shown in step 26.

After the digital video (movie, television episode, documentary, etc.) has been filmed and produced in the normal manner, as shown in step 26, post production begins in step 28. Post production typically includes preparing the video for either a direct release or a theatrical release. If the digital video is theatrically released, the post production editing shown in step 32 is delayed until the digital video is ready for direct release to consumers through any one of multiple different digital platforms.

In step 32, the digital film/video is post produced to add the shopping indicators and the product identification markers to individual screens as previously described. In addition, all of the hyperlinks to the on-line retailers are added to the product identification markers. All of this information is digitally stored along with the digital video. Once the product identification markers have been added to the digital video for the products that are placed within the digital video created by the filmmaker, the enhanced version of the digital video is released in step 34. The release of the enhanced digital video can be over a wide variety of video services currently available, such as but not limited to cable provides, satellite television providers, on-line streaming services such as Netflix, Amazon, Hutu, etc. It is anticipated that a greater number of digital video providers will be available as digital streaming of movies and television increases.

After release, the customer can playback a digital video on a wide variety of display devices. During playback, as described previously, the view can interact with the scenes within the digital video when the viewer sees the shopping indicator and a product on screen that is of interest. As described above, the viewer is made aware of the digital enhancements through a small, unobtrusive shopping indicator that can appear when tagged products are displayed within a frame on the screen. A brief introduction could be included at the start of the digital video to advise the viewer as to the availability of the digitally enhanced products and shopping feature contained within the video.

As shown in step 38, the viewer can shop for items that are identified in the digital video any time during the video viewing. The viewer can either wait until the video is completed to complete the shopping process or can immediately purchase products as desired. Once products are purchased, the orders are fulfilled in step 40 and products are sent to the viewer/customer from online merchants, such as Amazon, Zappos or any other online merchant.

The method and system of the present disclosure allows products to be placed within digital video and tagged with digital identification markers. While watching the digital video, a viewer can pause the video and view items that have been digitally tagged for purchase. If the viewer likes any of these objects, they can immediately purchase the items through an online shopping experience.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method of integrating product placement and on-line shopping into a digital video having a plurality of sequential frames, comprising:
assigning a product marker to each of a plurality of placed products in each of the plurality of frames in which the placed product is present;
assigning a shopping indicator to each of the frames that includes one or more of the placed products, wherein the shopping indicator is displayed during playing of the digital video; and
storing the product markers and shopping indicators along with the digital video for playback by a viewer on a display device.

2. The method of claim 1 wherein the shopping indicator is displayed in a predefined location in the frame during playback.

3. The method of claim 2 wherein the predefined location is unrelated to the location of the placed products.

4. The method of claim 1 wherein the product marker includes an electronic link to an information page for the placed product.

5. The method of claim 4 wherein the electronic link is to an on-line retailer of the placed product.

6. The method of claim 4 wherein the product marker is superimposed over the placed product on the displayed frame.

7. The method of claim 1 further creating the step of creating a plurality of introductory frames before the digital video instructing as to the availability of on-line shop during playback of the digital video.

8. The method of claim 5 further comprising the step of creating an informational display screen that includes both the digital video and a shopping status section, wherein the informational display screen is shown upon selection of the product markers by the viewer.

9. The method of claim 8 wherein the shopping status section includes pricing information retrieved from the on-line retailer.

10. The method of claim 9 wherein the shopping status section includes a purchase that allows the viewer to purchase the placed product from the on-line retailer.

11. A method of integrating product placement and on-line shopping into a digital video having a plurality of sequential scenes, comprising:
digitally assigning a product marker to each of a plurality of placed products in each of the frames in which the placed product is present;
digitally assigning a shopping indicator to each of the frames that includes one or more of the placed products;
playing the digital video on a display device;
visually displaying the shopping indicator for each of the frames that include one or more of the placed products;
receiving viewer input on the display device indicating an interest in one or more of the placed products;
pausing playback of the digital video and visually superimposing each of the product markers for each of the placed products included in the frame of the paused digital video;
receiving input from the viewer as to interest in one of the placed products; and
displaying information about the product to the viewer.

12. The method of claim 11 wherein the information includes current pricing information for the placed product.

13. The method of claim 11 wherein the displayed information includes a purchase link to purchase the placed product from within the digital video.

14. The method of claim 11 further comprising the step of creating a plurality of introductory frames before the digital video indicating the availability of on-line shopping during the digital video.

15. The method of claim 11 further comprising the step of creating an informational display screen that includes both the digital video and a shopping status section, wherein the informational display screen is shown upon selection of the product markers by the viewer.

16. The method of claim 15 wherein each of the product markers includes an electronic link to an on-line retailer of the placed product.

17. The method of claim 16 wherein the shopping status section includes pricing information retrieved from the on-line retailer.

18. The method of claim 17 wherein the shopping status section includes a purchase link to allow the viewer to purchase the placed product from the on-line retailer.

19. The method of claim 11 wherein the product markers and the shopping indicators are assigned after creation of the digital video.

20. A method of integrating product placement and on-line shopping into a digital video having a plurality of sequential scenes, comprising:
receiving the digital video including a plurality of placed products shown in the plurality of scenes;
digitally assigning a product marker to each of the plurality of placed products in each of the frames in which the placed product is present;
assigning an electronic link to an on-line supplier of the placed product for each of the product markers;
digitally assigning a shopping indicator to each of the frames that includes one or more of the placed products;
storing the plurality of product marks, electronic links and shopping indicators with the digital video;
playing the digital video on a display device;
visually displaying the shopping indicator for each of the frames that include one or more of the placed products;
receiving viewer input on the display device indicating an interest in one or more of the placed products;
pausing playback of the digital video and visually superimposing each of the product markers for each of the placed products included in the frame of the paused digital video;
receiving input from the viewer as to interest in one of the placed products;
utilizing the electronic link associated with the product marker superimposed over the placed product to obtain information about the placed product from the on-line supplier; and
displaying information about the placed product to the viewer.
